(19) United States
(12) Patent Application Publication
(10) Pub. No.: US 2026/0145513 A1
(43) Pub. Date: May 28, 2026

(54) COLUMN-TYPE ELECTRONIC SHIFT OPERATION APPARATUS

(71) Applicants: HYUNDAI MOTOR COMPANY, Seoul (KR); KIA CORPORATION, Seoul (KR); SL Corporation, Daegu (KR)

(72) Inventors: Jeong Seon Min, Hwaseong-si (KR); Ki Young Song, Hwaseong-si (KR); Kyeong Hwan Choi, Hwaseong-si (KR); Sang Eun Bae, Daegu (KR)

(73) Assignees: HYUNDAI MOTOR COMPANY, Seoul (KR); KIA CORPORATION, Seoul (KR); SL Corporation, Daegu (KR)

(21) Appl. No.: 19/201,620

(22) Filed: May 7, 2025

(30) Foreign Application Priority Data
Nov. 27, 2024 (KR) 10-2024-0172608

(51) Int. Cl. B60K 20/06; B60K 35/21; F16H 59/10

(52) U.S. Cl. CPC B60K 20/06; B60K 35/212; F16H 59/105; B60K 2360/172; B60K 2360/336; B60K 2360/42

(57) ABSTRACT

An electronic shift operation apparatus includes a shift position light guide having a structure integrated into a single component. The shift position light guide is provided between a light source of a gear shifter and an indicator configured to indicate a shift position. A P-shift position guide, an R-shift position guide, an N-shift position guide, and a D-shift position guide of the shift position light guide are connected to one another by a bridge.

### CROSS-REFERENCE TO RELATED APPLICATION

The present application claims priority to Korean Patent Application No. 10-2024-0172608, filed on Nov. 27, 2024, the entire contents of which are incorporated herein for all purposes by this reference.

### BACKGROUND

### Techinical Field

The present disclosure relates to a column-type electronic shift operation apparatus, and more particularly, to a technology related to a column-type electronic shift operation apparatus, in which a shift position light guide is applied.

### Related Art

In general, a vehicle equipped with an automatic transmission allows shift gears to automatically operate within a target shift position range by controlling hydraulic pressure within a shift range set in accordance with a traveling speed of the vehicle.

The automatic transmission creates a gear ratio by using a hydraulic circuit, a planetary gear, and friction elements to perform a shift operation, and a transmission control unit (TCU) controls the constituent components.

A shift-by-wire (SBW) system, which is an electronic transmission system for a vehicle, refers to an electronic transmission system having no mechanical connection structure, such as a cable, between a transmission and a gear shifter (e.g., a shift lever, a shift button, or a shift dial), unlike a mechanical transmission system in the related art. When a sensor value, which is generated when the gear shifter is manipulated, is transmitted to the transmission controller (TCU), the TCU performs electronic shift control in response to an instructed signal.

Examples of the electronic transmission systems include a lever-type electronic transmission system, a button-type electronic transmission system, a dial-type electronic transmission system, and a column-type electronic transmission system. In the column-type electronic transmission system among the electronic transmission systems, various functions related to vehicle traveling may be integrated with a column SBW in order to maximize the function of the SBW, reduce the number of peripheral components, and implement an aesthetic design.

In addition, in addition to the integration of the functions of the column SBW, a lighting function may also be applied to provide a driver with information on a current shift position and a shift pattern related to a shift position in order to ensure safety during a shift operation.

The foregoing explained as the background is intended merely to aid in the understanding of the background of the present disclosure, and is not intended to mean that the present disclosure falls within the purview of the related art that is already known to those having ordinary skill in the art.

### SUMMARY

The present disclosure is proposed to solve these problems and aims to provide a column-type electronic shift operation apparatus made by applying a starting unit and a lighting function to a gear shifter. The column-type electronic shift operation apparatus is configured such that a shift position light guide with an integrated structure is applied between a light source and an indicator configured to indicate a shift position, thereby eliminating lighting interference and light leakage, implementing lighting with maximum brightness, and improving safety.

In an embodiment of the present disclosure, an electronic shift operation apparatus includes: an indicator configured to indicate shift positions of a vehicle; light sources configured to be equal in number to the shift positions indicated by the indicator; and a shift position light guide configured to individually separate light beams emitted from the light sources and transmit the light beams to the indicator. The shift position light guide is integrated into a single component. The indicator, the light sources, and the shift position light guide are provided on a gear shifter configured to be manipulated by a driver to perform a shift operation. The electronic shift operation apparatus may be a column-type electronic shift operation apparatus.

In an embodiment, the indicator and the shift position light guide may be coupled to a base bracket of the gear shifter, a printed circuit board (PCB) may be coupled to a cover coupled to the base bracket, the light sources may be coupled to the PCB, the shift position light guide may include a prism, and the light beams from the light sources may pass through the prism and reach the indicator.

The shift position light guide may be coupled to a base bracket of the gear shifter by a snap-fit structure.

The shift positions of the vehicle indicated by the indicator may include a P-shift position, an R-shift position, an N-shift position, and a D-shift position, and the shift position light guide may include a P-shift position guide, an R-shift position guide, an N-shift position guide, and a D-shift position guide. The P-shift position guide, the R-shift position guide, the N-shift position guide, and the D-shift position guide may be matched, in a one-to-one manner, with the shift positions indicated by the indicator.

The P-shift position guide, the R-shift position guide, the N-shift position guide, and the D-shift position guide may each have ribs formed on surfaces of the P-shift position guide, the R-shift position guide, the N-shift position guide, and the D-shift position guide. The rib may come into line contact with a base bracket of the gear shifter when or based on that the shift position light guide is assembled to the base bracket.

A P-shift position guide insertion portion, into which the P-shift position guide is inserted, an R-shift position guide insertion portion, into which the R-shift position guide is inserted, an N-shift position guide insertion portion, into which the N-shift position guide is inserted, and a D-shift position guide insertion portion, into which the D-shift position guide is inserted, may be individually and separately provided in the base bracket of the gear shifter.

The P-shift position guide, the R-shift position guide, the N-shift position guide, and the D-shift position guide may be connected to one another by a bridge at one end adjacent to the light sources and separated from one another at the other end adjacent to the indicator.

A stepped portion structure (e.g., an upward/downward stepped portion structure) and a curvature portion structure may be provided to the bridge to disperse the light beams emitted from the light sources to a region excluding the P-shift position guide, the R-shift position guide, the N-shift position guide, and the D-shift position guide.

Arrangement structures of the P-shift position, the R-shift position, the N-shift position, and the D-shift position indicated by the indicator may be identical to arrangement structures of the P-shift position guide, the R-shift position guide, the N-shift position guide, and the D-shift position guide of the shift position light guide, the R-shift position guide, the N-shift position guide, and the D-shift position guide may be disposed in a row, the P-shift position guide may be disposed in parallel at one side of the N-shift position guide, and the bridge may connect the P-shift position guide, the R-shift position guide, the N-shift position guide, and the D-shift position guide at an outer periphery.

In an embodiment, the bridge may include: a first bridge configured to connect the P-shift position guide, the R-shift position guide, and the D-shift position guide at the outer periphery; and a second bridge connected to the first bridge and configured to connect, at the outer periphery, the N-shift position guide positioned between the R-shift position guide and the D-shift position guide.

The first bridge and a connection portion of the second bridge may be connected by an upward/downward stepped portion structure.

The bridge may further include a third bridge configured to connect the first bridge, the R-shift position guide, and the D-shift position guide.

Both the upward/downward stepped portion structure and a curvature portion structure may be provided to the third bridge.

The first bridge and the second bridge may each include a plurality of straight line sections. The adjacent straight line sections may be connected to each other and may define 90 degrees.

A connection route between the P-shift position guide and the R-shift position guide and a connection route between the P-shift position guide and the D-shift position guide made by the third bridge may each include two straight line sections from a viewing angle that the shift position light guide is viewed at a position opposite to a position of the light source. Both the upward/downward stepped portion structure and the curvature portion structure may be provided to the third bridge.

An edge portion of the second bridge may be formed in a round shape.

A bottom surface of the first bridge, a bottom surface of the P-shift position guide, a bottom surface the R-shift position guide, a bottom surface the N-shift position guide, and a bottom surface the D-shift position guide may be positioned on the same plane. The bottom surface of the P-shift position guide, the bottom surface of the R-shift position guide, the bottom surface of the N-shift position guide, and the bottom surface of the D-shift position guide face the light source. Edge portions may protrude leftward and rightward from the first bridge to discharge the light beams emitted from the light sources to the outside of the first bridge.

may further include: a starting unit coupled to the gear shifter and configured to be manipulated by the driver to start the vehicle. A partition wall may be provided on the base bracket and disposed between the starting unit and the shift position light guide to prevent the light beams emitted from the light sources from being transmitted to the starting unit through the shift position light guide.

In an embodiment of the present disclosure, an electronic shift operation apparatus includes: a gear shifter positioned on a steering column of a vehicle and configured to be manipulated by a driver to perform a shift operation; a starting unit provided on the gear shifter and configured to be manipulated to start the vehicle; and a shift position light guide provided on the gear shifter and configured to transmit light beams emitted from a light source to an indicator configured to indicate a shift position.

The number of shift positions of the vehicle indicated by the indicator may be two or more. The shift position light guide may have a structure integrated into a single component, individually separate the light beams emitted from the light source, and transmit the light beams to the shift positions indicated by the indicator.

### BRIEF DESCRIPTION OF THE DRAWINGS

FIG. 1 is a view of a column-type electronic shift operation apparatus according to an embodiment of the present disclosure.

FIG. 2 is a view of a gear shifter according to an embodiment of the present disclosure.

FIG. 3 is an exploded view of FIG. 2.

FIG. 4 is an exploded view illustrating components coupled to a base bracket in FIG. 3.

FIG. 5 is an exploded view illustrating components coupled to a cover in FIG. 3.

FIG. 6 is an exploded view of a PCB to which a shift position light guide and a light source are coupled according to an embodiment of the present disclosure.

FIGS. 7 to 10 are perspective views and a side view of a shift position light guide according to an embodiment of the present disclosure.

FIG. 11 is a top plan view of a shift position light guide according to an embodiment of the present disclosure.

FIG. 12 is a view for explaining connection routes between a first bridge, a second bridge, and a third bridge in a shift position light guide according to an embodiment of the present disclosure.

FIG. 13 is a bottom plan view of a shift position light guide according to an embodiment of the present disclosure.

FIG. 14 is an enlarged view of a portion of a base bracket to which the shift position light guide is coupled according to an embodiment of the present disclosure.

FIG. 15 is a view illustrating a state in which a shift position light guide is coupled to a base bracket according to an embodiment of the present disclosure.

FIG. 16 is a cross-sectional view of FIG. 15.

FIG. 17 is a view for explaining a rib of a shift position light guide according to an embodiment of the present disclosure.

FIG. 18 is a view for explaining a partition wall of a base bracket according to an embodiment of the present disclosure.

The drawings described herein are for illustration purposes only and are not intended to limit the scope of the present disclosure in any way.

### DETAILED DESCRIPTION

In the description of embodiments disclosed in the present specification, the specific descriptions of publicly known related technologies have been omitted when it is determined that the specific descriptions may obscure the subject matter of embodiments disclosed in the present specification. In addition, it should be interpreted that the accompanying drawings are provided only to allow those having ordinary skill in the art to easily understand embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

The suffixes “module”, “unit”, “part”, and “portion” used to describe constituent elements in the following description are used together or interchangeably in order to facilitate the description, but the suffixes themselves do not have distinguishable meanings or functions.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

In addition, the term “control unit” or “unit” included in the name of “motor control unit (MCU)” or “hybrid control unit (HCU)” is merely a term widely used to name a control device (controller or control unit) for controlling a particular vehicle function but does not mean a generic function unit.

When a component, device, element, apparatus, or the like of the present disclosure is described as having a purpose or performing an operation, function, or the like, the component, device, element, apparatus, or the like should be considered herein as being “configured to” meet that purpose or to perform that operation or function.

A controller may include a communication device configured to communicate with another control unit or a sensor to control a corresponding function, a memory configured to store an operating system, a logic instruction, and input/output information, and one or more processors configured to perform determination, computation, decision, or the like required to control the corresponding function.

Hereinafter, embodiments disclosed in the present specification are described in detail with reference to the accompanying drawings. The same or similar constituent elements are assigned with the same reference numerals regardless of reference numerals, and the repetitive description thereof has been omitted.

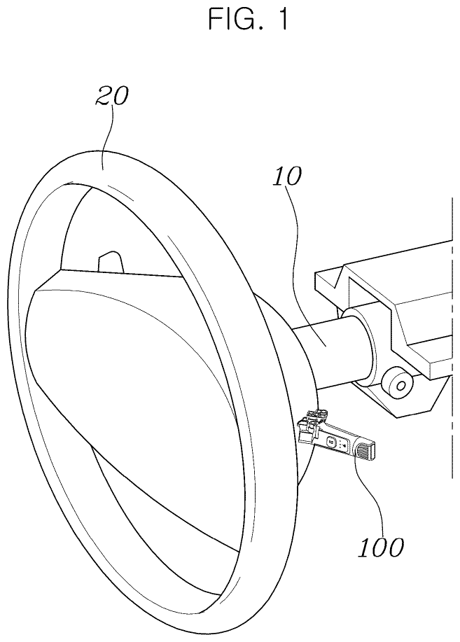

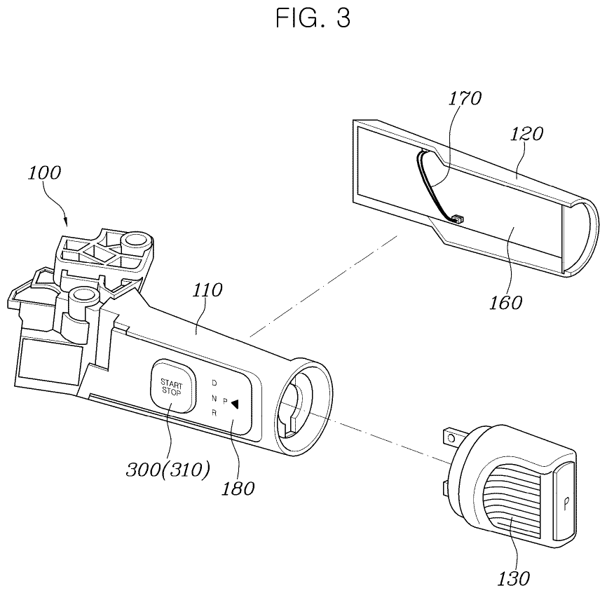

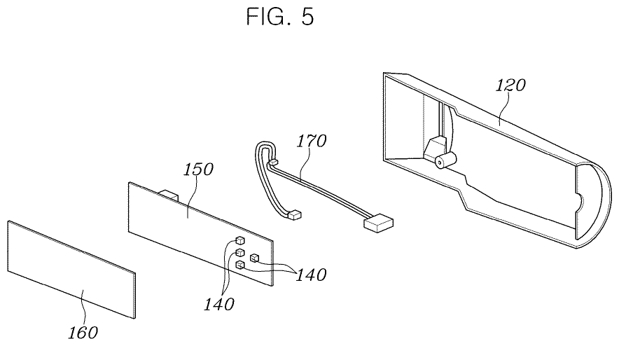

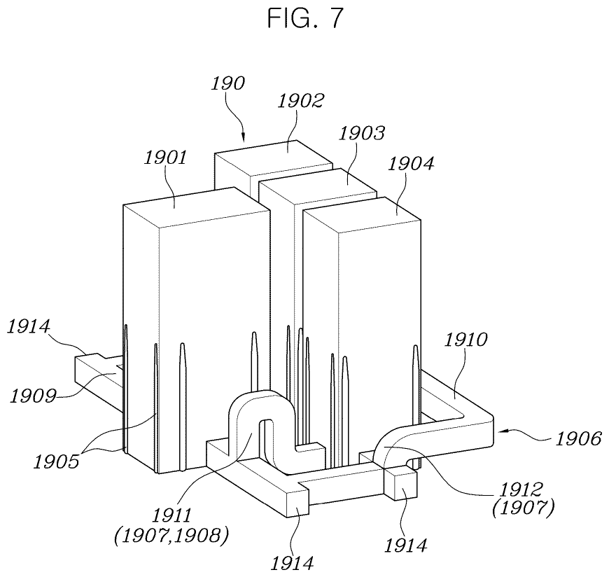

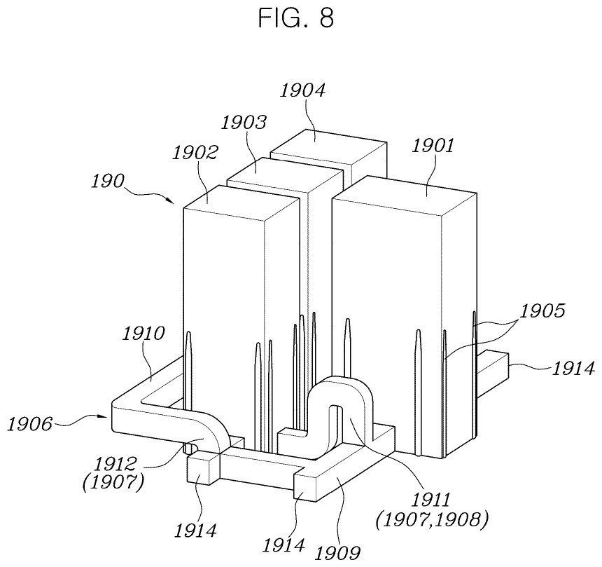

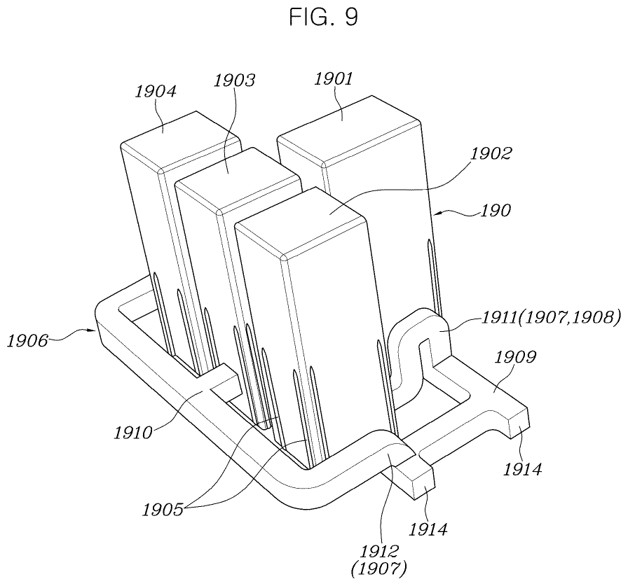

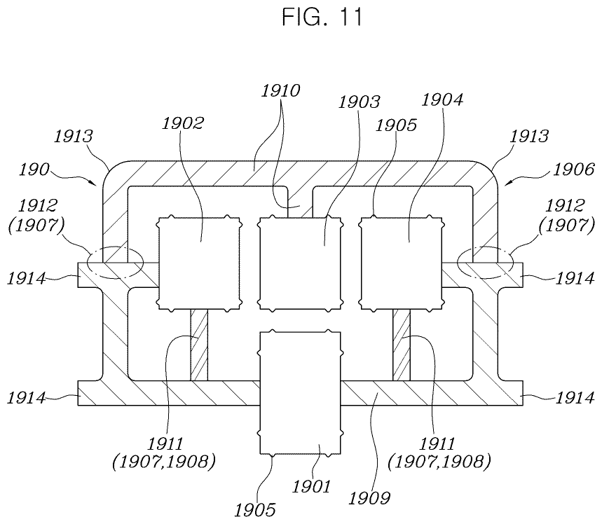

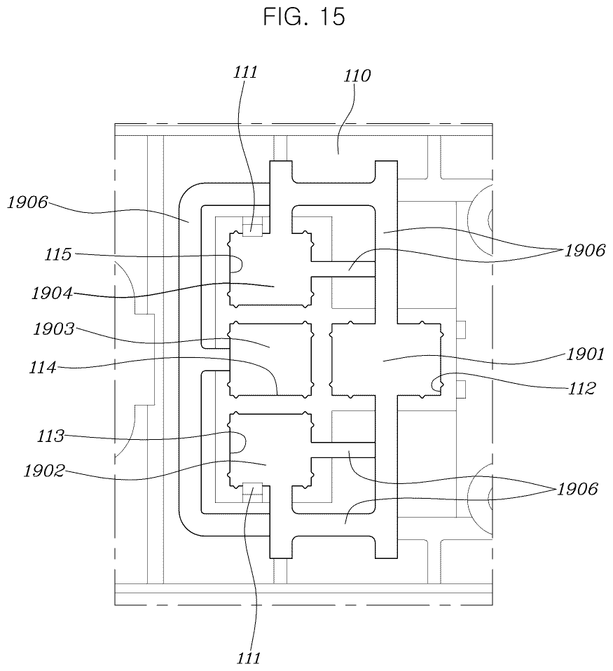

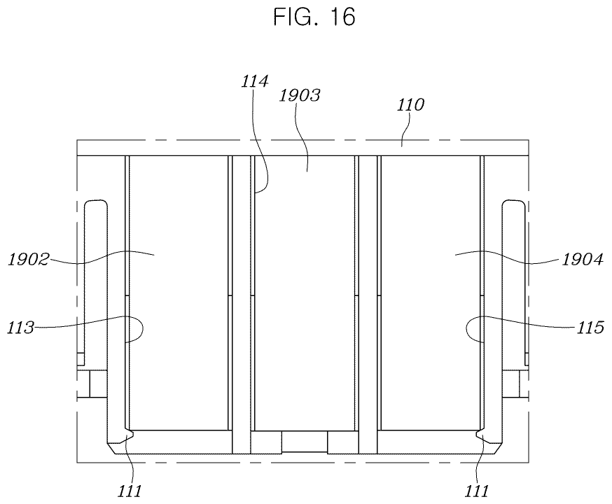

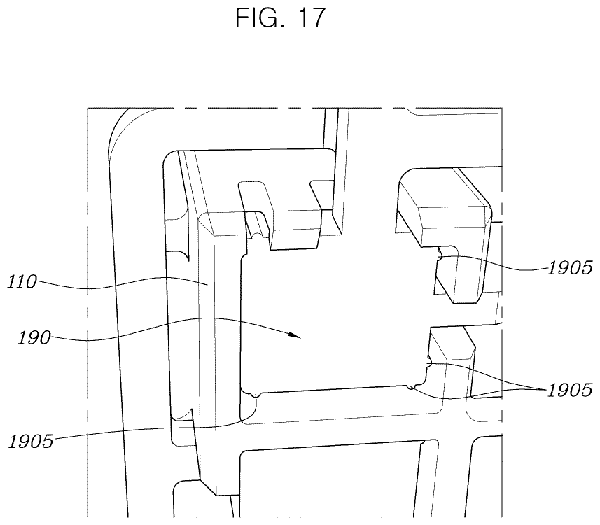

As illustrated in FIGS. 1-18 , in a column-type electronic shift operation apparatus according to an embodiment of the present disclosure, a gear shifter 100, which is manipulated by a driver to perform a shift operation, may be coupled to a steering column 10 of a vehicle, and a starting unit 300, which is manipulated by the driver to start the vehicle, may be provided on the gear shifter 100.

In addition, a lighting function may also be applied to the gear shifter 100 and provide the driver with information on a current shift position and a shift pattern related to a shift position in order to ensure safety during a shift operation.

In case that the starting unit 300 is provided on the gear shifter 100 as described above, an external size of the gear shifter 100 is inevitably increased to ensure an operation stroke of the starting unit 300, and a distance between light sources 140, which perform lighting, and an indicator 180, which indicates the shift positions, is increased as the size of the gear shifter 100 increases. For this reason, there is a concern that luminance dissatisfaction and light interference may occur.

An embodiment according to the present disclosure may provide the column-type electronic shift operation apparatus made by applying both the starting unit 300 and the lighting function to the gear shifter 100, in which a shift position light guide 190 with an integrated structure is provided between the light sources 140 and the indicator 180 configured to indicate the shift position. Therefore, the maximum brightness of the lighting for allowing the indicator 180 to indicate the shift position may be implemented by the shift position light guide 190, thereby coping with luminance dissatisfaction, light interference, and light leak and improving safety and marketability.

With reference to FIG. 1, the gear shifter 100, which is manipulated by the driver to perform the shift operation, may be provided on the steering column 10 of the vehicle.

Reference numeral 20 in FIG. 1 may indicate a steering wheel.

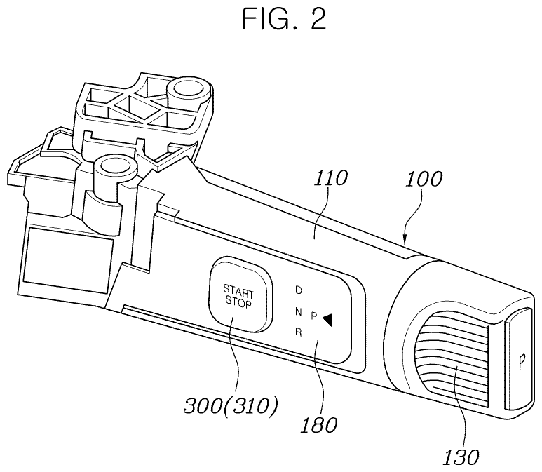

With reference to FIGS. 2-6 , the gear shifter 100 according to an embodiment of the present disclosure may include a base bracket 110 coupled to the steering column 10 and configured to define an overall external shape of the gear shifter 100, a cover 120 provided forward of the base bracket 110 and coupled to the base bracket 110 by a snap-fit structure, and a knob 130 rotatably coupled to an end of the base bracket 110 and configured to be manipulated by the driver to select the shift position.

A printed circuit board (PCB) 150, to which the light sources 140 with a plurality of light-emitting diodes (LEDs) are coupled, may be coupled to the cover 120, and a PCB rubber 160 and a wire 170 may be coupled to the cover 120.

The indicator 180, which indicates the shift position of the vehicle, may be coupled to the base bracket 110. The shift position light guide 190 may be coupled to the base bracket 110. The shift position light guide 190 may individually separate light beams emitted from the light sources 140, transmit the light beams to the indicator 180, and be integrated into a single component.

The shift positions including a P-shift position, an R-shift position, an N-shift position, and a D-shift position may be indicated by the indicator 180. The light sources 140 may be equal in number to the shift positions indicated by the indicator 180.

In other words, the light sources 140 may include a P-shift position light source 141, an R-shift position light source 142, an N-shift position light source 143, and a D-shift position light source 144.

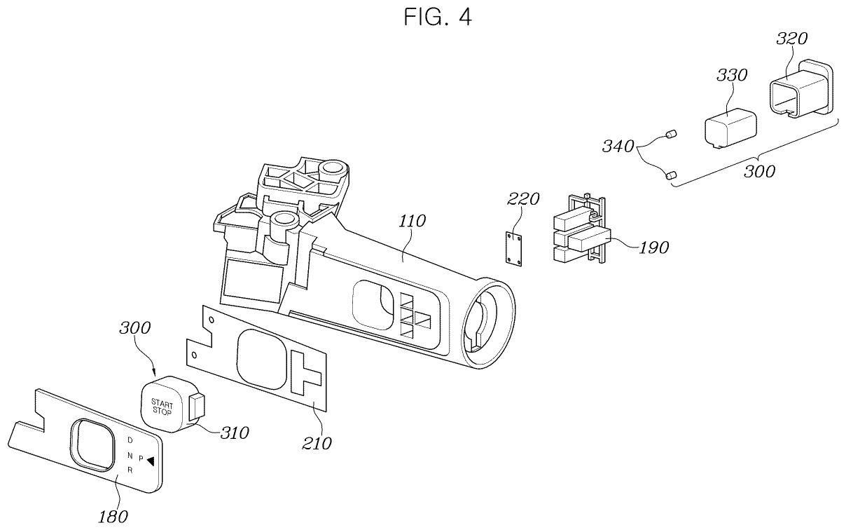

Reference numeral 210 illustrated in FIG. 4 indicates a double-sided tape for coupling the indicator 180 to the base bracket 110, and reference numeral 220 indicates a magnet block for preventing magnetic field disturbance.

The shift position light guide 190 may be configured as a prism, and the light beams from the light sources 140 may pass through the prism and reach the indicator 180.

In an embodiment according to the present disclosure, the starting unit 300, which is manipulated by the driver to start the vehicle, may also be provided on the gear shifter 100.

The starting unit 300 may include a start button 310, a start button guide 320 connected to the start button 310 and configured to transmit a stroke to the PCB rubber 160 when the start button 310 is manipulated, a start button light guide 330 coupled to the start button guide 320 and configured to transmit the light beams from the light sources to the start button 310, and a damper 340 configured to prevent noise when the start button 310 is returned.

The start button light guide 330 may be configured as a prism. However, the present disclosure is not limited thereto.

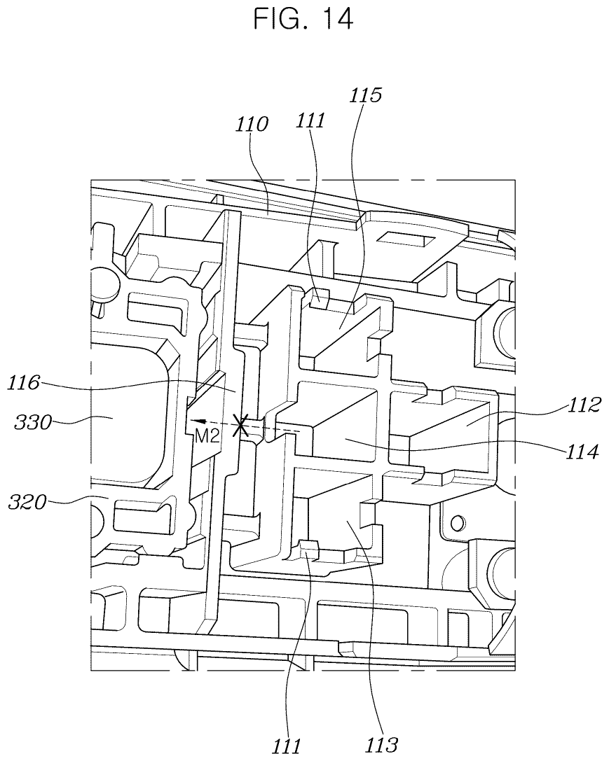

With reference to FIGS. 14-16 , the shift position light guide 190 according to an embodiment of the present disclosure may be coupled to the base bracket 110 of the gear shifter 100 by using snap-fit structures 111, which may ensure ease of assembling.

The plurality of snap-fit structures 111, which is each formed as a protrusion with a triangular cross-section, may be provided on the base bracket 110, such that the shift position light guide 190 may be fixedly coupled to the base bracket 110 of the gear shifter 100 by using the snap-fit coupling structures 111.

The shift position light guide 190 according to an embodiment of the present disclosure may include a P-shift position guide 1901, an R-shift position guide 1902, an N-shift position guide 1903, and a D-shift position guide 1904 matched, in a one-to-one manner, with the shift positions (the P-shift position, the R-shift position, the N-shift position, and the D-shift position) indicated by the indicator 180.

The P-shift position guide 1901, the R-shift position guide 1902, the N-shift position guide 1903, and the D-shift position guide 1904 may individually separate the light beams emitted from the P-shift position light source 141, the R-shift position light source 142, the N-shift position light source 143, and the D-shift position light source 144 and transmit the light beams to the indicator 180, such that the P-shift position, the R-shift position, the N-shift position, and the D-shift position may be indicated by the indicator 180 by lighting.

An external shape of each of the P-shift position guide 1901, the R-shift position guide 1902, the N-shift position guide 1903, and the D-shift position guide 1904 may be a quadrangular column shape. However, the present disclosure is not limited thereto.

The P-shift position guide 1901, the R-shift position guide 1902, the N-shift position guide 1903, and the D-shift position guide 1904 may each have two or more ribs 1905 provided on each surface thereof.

The rib 1905 may extend in a longitudinal direction of the guide and have a cross-section with an arc shape. The rib 1905 may come into line contact with the base bracket 110 when the shift position light guide 190 is assembled to the base bracket 110 of the gear shifter 100.

With the ribs 1905 that induce the line contact between the base bracket 110 and the shift position light guide 190, the shift position light guide 190 may ensure ease of assembling. In particular, a clearance from the base bracket 110 may be minimized, which may improve durability.

A P-shift position guide insertion portion 112, into which the P-shift position guide 1901 is inserted, an R-shift position guide insertion portion 113, into which the R-shift position guide 1902 is inserted, an N-shift position guide insertion portion 114, into which the N-shift position guide 1903 is inserted, and a D-shift position guide insertion portion 115, into which the D-shift position guide 1904 is inserted, may be individually and separately provided in the base bracket 110.

The P-shift position guide insertion portion 112, the R-shift position guide insertion portion 113, the N-shift position guide insertion portion 114, and the D-shift position guide insertion portion 115 may each be formed as a hole having a quadrangular cross-section.

The P-shift position guide insertion portion 112, the R-shift position guide insertion portion 113, the N-shift position guide insertion portion 114, and the D-shift position guide insertion portion 115 may each be formed in a quadrangular shape and surround the P-shift position guide 1901, the R-shift position guide 1902, the N-shift position guide 1903, and the D-shift position guide 1904, such that the light beams emitted from the light sources 140 are prevented or inhibited from being transmitted between the guides at the shift positions, thereby implementing an effect of blocking the light.

The P-shift position guide 1901, the R-shift position guide 1902, the N-shift position guide 1903, and the D-shift position guide 1904 of the shift position light guide 190 according to an embodiment of the present disclosure are connected to one another by a bridge 1906 at one end adjacent to the light source 140 and thus integrated into a single component. The P-shift position guide 1901, the R-shift position guide 1902, the N-shift position guide 1903, and the D-shift position guide 1904 are separated without being connected to one another at the other end adjacent to the indicator 180. The other ends, which are separated from one another, may be respectively inserted into the P-shift position guide insertion portion 112, the R-shift position guide insertion portion 113, the N-shift position guide insertion portion 114, and the D-shift position guide insertion portion 115.

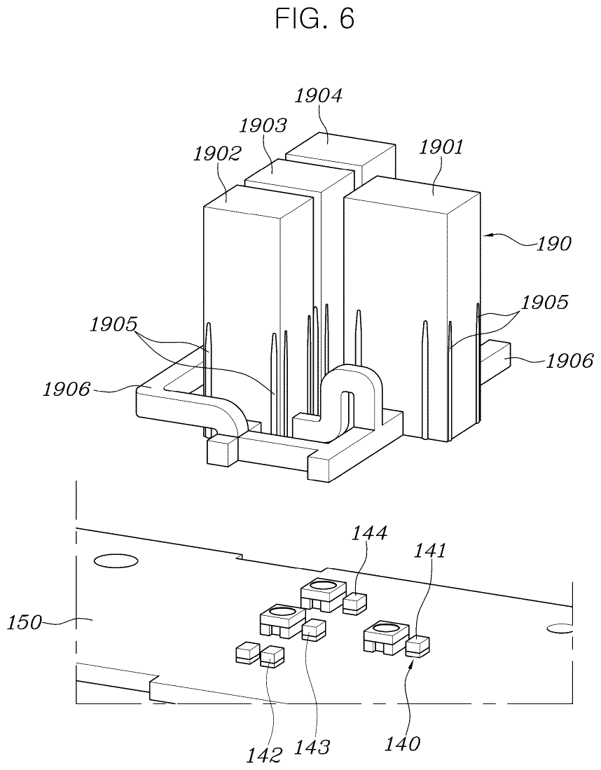

With reference to FIG. 6, the P-shift position guide 1901, the R-shift position guide 1902, the N-shift position guide 1903, and the D-shift position guide 1904 may be connected to one another by the bridge 1906 at a lower end adjacent to the light source 140 and separated from one another without being connected to one another at an upper end opposite to the lower end.

In case that the shift position light guides are individually set for the respective shift positions (the P-shift position, the R-shift position, the N-shift position, and the D-shift position) indicated by the indicator 180, there may occur a problem in that the number of components is increased, and the assembling process is complicated.

In order to prevent the problem, the present disclosure employs the structure in which the P-shift position guide 1901, the R-shift position guide 1902, the N-shift position guide 1903, and the D-shift position guide 1904 are connected to one another by the bridge 1906 and integrated so that the shift position light guide 190 is a single component, the single shift position light guide 190 performs the shift position lighting function of the indicator 180, and the P-shift position guide 1901, the R-shift position guide 1902, the N-shift position guide 1903, and the D-shift position guide 1904 are separated without being connected to one another at the other end adjacent to the indicator 180.

The light emitted from the light sources 140 is gradually weakened while moving along the bridge 1906, and the light having passed through the bridge 1906 is not transmitted to the indicator 180 because of the position of the bridge 1906 and a light-emitting angle, which may prevent a situation in which the light beams interfere with one another at the shift positions of the indicator 180.

A structure having an upward/downward stepped portion 1907 and a curvature portion 1908 may be provided to the bridge 1906 of the present disclosure to disperse the light beams emitted from the light sources 140 to a region excluding the P-shift position guide 1901, the R-shift position guide 1902, the N-shift position guide 1903, and the D-shift position guide 1904.

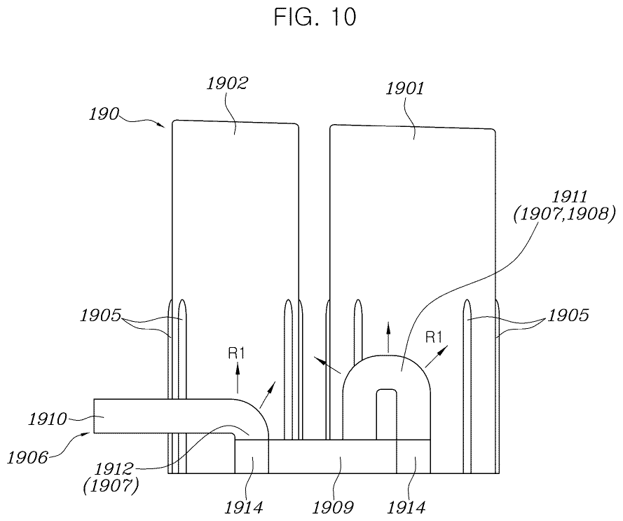

The upward/downward stepped portion 1907 and the curvature portion 1908 provided on the bridge 1906 may serve to disperse the light beams emitted from the light sources 140 to the region excluding the P-shift position guide 1901, the R-shift position guide 1902, the N-shift position guide 1903, and the D-shift position guide 1904 (arrows R1 in FIG. 10). Therefore, it is possible to prevent a leak of light, minimize light interference, and prevent a mixture of light.

According to an embodiment of the present disclosure, the arrangement structures of the P-shift position, the R-shift position, the N-shift position, and the D-shift position indicated by the indicator 180 may be identical to the arrangement structures of the P-shift position guide 1901, the R-shift position guide 1902, the N-shift position guide 1903, and the D-shift position guide 1904 of the shift position light guide 190.

Further, the R-shift position guide 1902, the N-shift position guide 1903, and the D-shift position guide 1904 may be disposed in a row, the P-shift position guide 1901 may be disposed in parallel at one side of the N-shift position guide 1903, and the bridge 1906 may be configured to connect the P-shift position guide 1901, the R-shift position guide 1902, the N-shift position guide 1903, and the D-shift position guide 1904 at an outer periphery.

The shift position light guide 190 requires the P-shift position guide 1901, the R-shift position guide 1902, the N-shift position guide 1903, and the D-shift position guide 1904 to illuminate the shift positions including the P-shift position, the R-shift position, the N-shift position, and the D-shift position of the indicator 180, and the connection structure using the bridge 1906 is required to configure the P-shift position guide 1901, the R-shift position guide 1902, the N-shift position guide 1903, and the D-shift position guide 1904 as the single component.

The bridge 1906 may be structured to connect the P-shift position guide 1901, the R-shift position guide 1902, the N-shift position guide 1903, and the D-shift position guide 1904 inward. In this case, when the bridge 1906 is connected at a height close to the light source 140, there is a concern that a leak of light may occur as the light beams emitted from the light sources 140 are mixed between the adjacent guides. In addition, there is a problem in that the light beams mixed by the leak of light are transmitted to the indicator 180. In contrast, in case that the bridge 1906 is connected at a height distant from the light source 140, the light beams are mixed at a position close to a surface of the indicator 180, which may cause a leak of light recognized by a customer's eyes.

Therefore, in the present disclosure, in order to prevent a leak of light and a mixture of light beams, a structure is basically provided in which the bridge 1906 connects the P-shift position guide 1901, the R-shift position guide 1902, the N-shift position guide 1903, and the D-shift position guide 1904 at the outer periphery (outward) without connecting the P-shift position guide 1901, the R-shift position guide 1902, the N-shift position guide 1903, and the D-shift position guide 1904 inward.

The bridge 1906 according to an embodiment of the present disclosure may include a first bridge 1909 configured to connect the P-shift position guide 1901, the R-shift position guide 1902, and the D-shift position guide 1904 at the outer periphery, a second bridge 1910 connected to the first bridge 1909 configured to connect, at the outer periphery, the N-shift position guide 1903 positioned between the R-shift position guide 1902 and the D-shift position guide 1904, and a third bridge 1911 configured to connect the first bridge 1909, the R-shift position guide 1902, and the D-shift position guide 1904.

Further, the first bridge 1909 and connection portions 1912 of the second bridge 1910 may be connected by the structure of the upward/downward stepped portion 1907, and the structure of the upward/downward stepped portion 1907 may prevent a leak of light, minimize light interference, and prevent a mixture of light.

The third bridge 1911 may maintain more secure strength and rigidity of the structure in which the R-shift position guide 1902 and the D-shift position guide 1904 are integrated.

In other words, in the structure in which the P-shift position guide 1901, the R-shift position guide 1902, the N-shift position guide 1903, and the D-shift position guide 1904 are connected to be integrated into a single component by the bridge 1906, the third bridge 1911 may serve to more securely connect the connection structures of the R-shift position guide 1902 and the D-shift position guide 1904, thereby reinforcing overall durability of the shift position light guide 190.

Both the structure of the upward/downward stepped portion 1907 and the structure of the curvature portion 1908 may be provided to the third bridge 1911, thereby preventing a leak of light, minimizing light interference, and preventing a mixture of light.

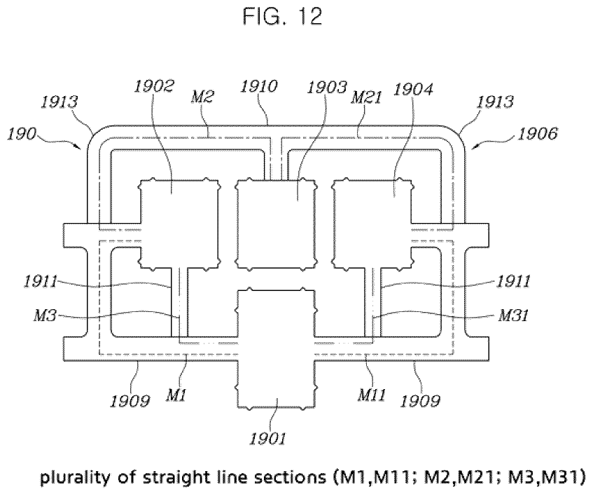

FIG. 12 is a top plan view illustrating the shift position light guide 190 when viewed at a position opposite to the position of the light source 140.

With reference to FIG. 12, the first bridge 1909 and the second bridge 1910 may each include a plurality of straight line sections M1,M11; M2,M21; M3,M31, and the adjacent straight line sections may be connected to each other while defining 90 degrees.

In more detail, as illustrated in FIG. 12, when the shift position light guide 190 is viewed, a connection route M1 between the P-shift position guide 1901 and the R-shift position guide 1902 and a connection route M11 between the P-shift position guide 1901 and the D-shift position guide 1904 made by the first bridge 1909 may be connected by a structure including three straight line sections.

In addition, a connection route M2 between the R-shift position guide 1902 and the N-shift position guide 1903 and a connection route M21 between the N-shift position guide 1903 and the D-shift position guide 1904 made by the second bridge 1910 may be connected by a structure including three straight line sections.

The connection routes M1, M11, M2, and M21 between the first bridge 1909 and the second bridge 1910 including at least three or more straight line sections may increase a movement route of the light and thus reduce the transmission amount of light, and the light may be refracted at positions at which the directions of the straight line sections are changed, such that the transmission amount of light may be reduced, thereby preventing a leak of light, minimizing light interference, and prevent a mixture of light.

In addition, as illustrated in FIG. 12, when the shift position light guide 190 is viewed, a connection route M3 between the P-shift position guide 1901 and the R-shift position guide 1902 and a connection route M31 between the P-shift position guide 1901 and the D-shift position guide 1904 made by the third bridge 1911 may be connected by a structure including two straight line sections.

As described above, in order to increase the connection routes M3 and M31 of the third bridge 1911 including the two straight line sections, both the structure of the upward/downward stepped portion 1907 and the structure of the curvature portion 1908 may be provided to the third bridge 1911.

The structure of the upward/downward stepped portion 1907 and the structure of the curvature portion 1908 may increase the connection routes M3 and M31 of the third bridge 1911, thereby preventing a leak of light, minimizing light interference, and preventing a mixture of light.

An edge portion 1913 of the second bridge 1910 may be formed in a round shape to prevent damage caused by interference with the peripheral components. However, the present disclosure is not limited thereto.

In addition, the edge portion 1913 of the second bridge 1910 is formed so that a thickness, a width, or an area thereof relatively decreases in comparison with other peripheral parts, thereby reducing the size and weight.

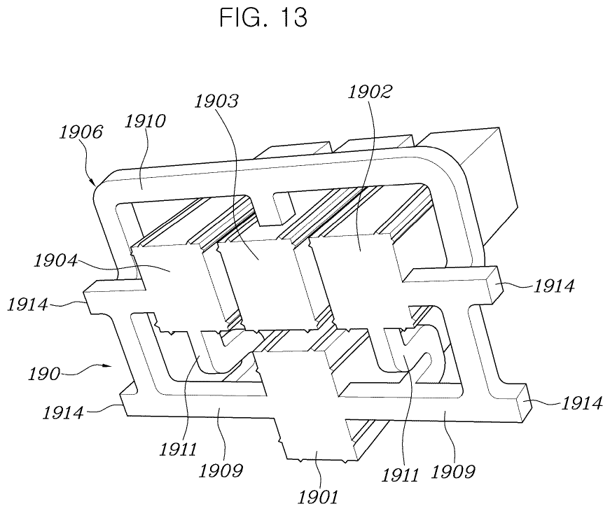

With reference to FIG. 13, a bottom surface of the first bridge 1909 and bottom surfaces of the P-shift position guide 1901, the R-shift position guide 1902, the N-shift position guide 1903, and the D-shift position guide 1904 of the shift position light guide 190, which face the light source 140, may be positioned on the same plane. Edge portions 1914 may protrude leftward and rightward from the first bridge 1909 to discharge the light beams emitted from the light sources to the outside of the first bridge 1909.

In case that the bottom surface of the first bridge 1909 is positioned on on the same plane as the bottom surfaces of the P-shift position guide 1901, the R-shift position guide 1902, the N-shift position guide 1903, and the D-shift position guide 1904, the edge portions 1914 serve to discharge the light beams emitted from the light sources 140 to the outside of the first bridge 1909 to prevent the light transmission by the first bridge 1909, thereby minimizing light interference and preventing a mixture of light.

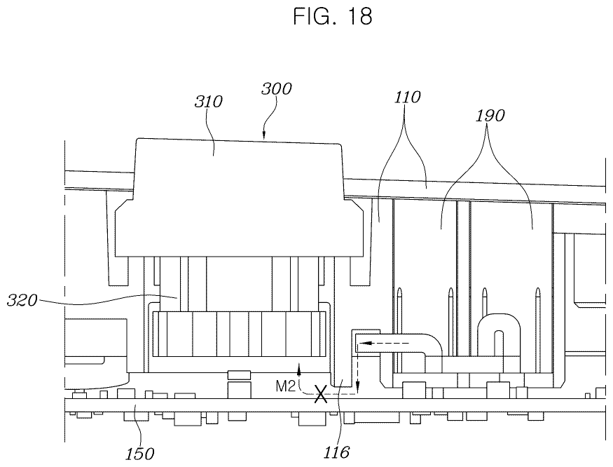

With reference to FIG. 18, in an embodiment according to the present disclosure, in the configuration in which the starting unit 300 is provided on the gear shifter 100, a partition wall 116 may be provided on the base bracket 110 and disposed between the starting unit 300 and the shift position light guide 190 to prevent the light beams emitted from the light sources 140 from being transmitted to the starting unit 300 through the shift position light guide 190, thereby minimizing light interference minimum and preventing a mixture of light.

In FIG. 18, arrow M2 indicates a route along which the light beams emitted from the light sources 140 are transmitted to the starting unit 300 through the shift position light guide 190, and mark X indicated on the route M2 means a situation in which the light is blocked by the partition wall 116 and cannot be transmitted to the starting unit 300.

The column-type electronic shift operation apparatus according to an embodiment of the present disclosure may include the gear shifter 100 coupled to the steering column 10 of the vehicle and configured to be manipulated by the driver to perform the shift operation, the starting unit 300 provided on the gear shifter 100 and configured to be manipulated to start the vehicle, and the shift position light guide 190 provided on the gear shifter 100 and configured to transmit the light beams emitted from the light sources 140 to the indicator 180 configured to indicate the shift positions.

The shift positions of the vehicle indicated by the indicator 180 according to an embodiment of the present disclosure may include two or more shift positions. The shift position light guide 190 may have the structure integrated into the single component, such that the light beams emitted from the light sources 140 may be individually and separately transmitted to the shift positions indicated by the indicator 180.

The column-type electronic shift operation apparatus according to an embodiment of the present disclosure described above is configured such that in the configuration in which the starting unit 300 is provided on the gear shifter 100, the shift position light guide 190 with the structure integrated into the single component is provided between the light sources 140 and the indicator 180 configured to indicate the shift positions, such that the maximum brightness of the lighting for allowing the indicator 180 to indicate the shift positions may be implemented by the shift position light guide 190, thereby coping with luminance dissatisfaction and improving marketability.

In addition, according to an embodiment of the present disclosure, the P-shift position guide 1901, the R-shift position guide 1902, the N-shift position guide 1903, and the D-shift position guide 1904, which constitute the shift position light guide 190, may individually separate the light beams emitted from the P-shift position light source 141, the R-shift position light source 142, the N-shift position light source 143, and the D-shift position light source 144 and transmit the light beams to the indicator 180, such that the P-shift position, the R-shift position, the N-shift position, and the D-shift position may be indicated by the indicator 180 by lighting. Therefore, it is possible to prevent a leak of light and light interference, in which the light beams emitted from the light sources 140 are mixed, and thus improve the safety and marketability.

The column-type electronic shift operation apparatus according to an embodiment of the present disclosure is configured such that in the configuration in which the starting unit is provided on the gear shifter, the shift position light guide with the structure integrated into the single component is applied between the light sources and the indicator configured to indicate the shift positions, such that the maximum brightness of the lighting for allowing the indicator to indicate the shift positions may be implemented by the shift position light guide, thereby coping with luminance dissatisfaction and improving marketability.

In addition, according to an embodiment of the present disclosure, the P-shift position guide, the R-shift position guide, the N-shift position guide, and the D-shift position guide, which constitute the shift position light guide, may individually separate the light beams emitted from the P-shift position light source, the R-shift position light source, the N-shift position light source, and the D-shift position light source and transmit the light beams to the indicator, such that the P-shift position, the R-shift position, the N-shift position, and the D-shift position may be indicated by the indicator by lighting. Therefore, it is possible to prevent a leak of light and light interference, in which the light beams emitted from the light sources are mixed, and thus improve the safety and marketability.

The effects obtained by the present disclosure are not limited to the aforementioned effects, and other effects, which are not mentioned above, should be more clearly understood by those having ordinary skill in the art from the above description.

While the specific embodiments of the present disclosure have been illustrated and described, it should be apparent to those having ordinary skill in the art that the present disclosure may be variously modified and changed without departing from the technical spirit of the present disclosure defined in the appended claims.

What is claimed is:

1. An electronic shift operation apparatus comprising:
an indicator configured to indicate shift positions of a vehicle;
light sources configured to be equal in number to the shift positions indicated by the indicator; and
a shift position light guide configured to individually separate light beams emitted from the light sources and transmit the light beams to the indicator, wherein the shift position light guide is integrated into a single component,
wherein the indicator, the light sources, and the shift position light guide are provided on a gear shifter configured to be manipulated by a driver to perform a shift operation.

2. The electronic shift operation apparatus of claim 1, wherein:
the indicator and the shift position light guide are coupled to a base bracket of the gear shifter;
a printed circuit board (PCB) is coupled to a cover coupled to the base bracket;
the light sources are coupled to the PCB;
the shift position light guide includes a prism; and
the light beams from the light sources are configured to pass through the prism and reach the indicator.

3. The electronic shift operation apparatus of claim 2, further comprising:
a starting unit coupled to the gear shifter and configured to start the vehicle,
wherein a partition wall is provided on the base bracket and disposed between the starting unit and the shift position light guide to prevent the light beams emitted from the light sources from being transmitted to the starting unit through the shift position light guide.

4. The electronic shift operation apparatus of claim 1, wherein the shift position light guide is coupled to a base bracket of the gear shifter by a snap-fit structure.

5. The electronic shift operation apparatus of claim 1, wherein:
the shift positions of the vehicle indicated by the indicator comprise a P-shift position, an R-shift position, an N-shift position, and a D-shift position; and
the shift position light guide comprises a P-shift position guide, an R-shift position guide, an N-shift position guide, and a D-shift position guide, wherein the P-shift position guide, the R-shift position guide, the N-shift position guide, and the D-shift position guide are matched, in a one-to-one manner, with the shift positions indicated by the indicator.

6. The electronic shift operation apparatus of claim 5, wherein the P-shift position guide, the R-shift position guide, the N-shift position guide, and the D-shift position guide each have ribs formed on surfaces of the P-shift position guide, the R-shift position guide, the N-shift position guide, and the D-shift position guide, and
wherein the rib comes into line contact with a base bracket of the gear shifter based on that the shift position light guide is assembled to the base bracket.

7. The electronic shift operation apparatus of claim 5, wherein a P-shift position guide insertion portion, into which the P-shift position guide is inserted, an R-shift position guide insertion portion, into which the R-shift position guide is inserted, an N-shift position guide insertion portion, into which the N-shift position guide is inserted, and a D-shift position guide insertion portion, into which the D-shift position guide is inserted, are individually and separately provided in a base bracket of the gear shifter.

8. The electronic shift operation apparatus of claim 5, wherein the P-shift position guide, the R-shift position guide, the N-shift position guide, and the D-shift position guide are connected to one another by a bridge at one end adjacent to the light sources and separated from one another at another end adjacent to the indicator.

9. The electronic shift operation apparatus of claim 8, wherein a stepped portion structure and a curvature portion structure are provided to the bridge to disperse the light beams emitted from the light sources to a region excluding the P-shift position guide, the R-shift position guide, the N-shift position guide, and the D-shift position guide.

10. The electronic shift operation apparatus of claim 8, wherein:
arrangement structures of the P-shift position, the R-shift position, the N-shift position, and the D-shift position indicated by the indicator are identical to arrangement structures of the P-shift position guide, the R-shift position guide, the N-shift position guide, and the D-shift position guide of the shift position light guide;
the R-shift position guide, the N-shift position guide, and the D-shift position guide are disposed in a row;
the P-shift position guide is disposed in parallel at one side of the N-shift position guide; and
the bridge connects the P-shift position guide, the R-shift position guide, the N-shift position guide, and the D-shift position guide at an outer periphery.

11. The electronic shift operation apparatus of claim 10, wherein the bridge comprises:
a first bridge configured to connect the P-shift position guide, the R-shift position guide, and the D-shift position guide at the outer periphery; and
a second bridge connected to the first bridge and configured to connect, at the outer periphery, the N-shift position guide positioned between the R-shift position guide and the D-shift position guide.

12. The electronic shift operation apparatus of claim 11, wherein the first bridge and a connection portion of the second bridge are connected by a stepped portion structure.

13. The electronic shift operation apparatus of claim 11, wherein the bridge further comprises a third bridge configured to connect the first bridge, the R-shift position guide, and the D-shift position guide.

14. The electronic shift operation apparatus of claim 13, wherein the first bridge and the second bridge each comprise a plurality of straight line sections, and
wherein adjacent straight line sections are connected to each other and define 90 degrees.

15. The electronic shift operation apparatus of claim 13, wherein a connection route between the P-shift position guide and the R-shift position guide and a connection route between the P-shift position guide and the D-shift position guide made by the third bridge each comprise two straight line sections from a viewing angle that the shift position light guide is viewed at a position opposite to a position of the light source, and
wherein a stepped portion structure and a curvature portion structure are provided to the third bridge.

16. The electronic shift operation apparatus of claim 11, wherein a stepped portion structure and a curvature portion structure are provided to a third bridge.

17. The electronic shift operation apparatus of claim 11, wherein an edge portion of the second bridge is formed in a round shape.

18. The electronic shift operation apparatus of claim 11, wherein a bottom surface of the first bridge, a bottom surface of the P-shift position guide, a bottom surface of the R-shift position guide, a bottom surface of the N-shift position guide, and a bottom surface of the D-shift position guide are positioned on a same plane, wherein the bottom surface of the P-shift position guide, the bottom surface of the R-shift position guide, the bottom surface of the N-shift position guide, and the bottom surface of the D-shift position guide face the light source, and
wherein edge portions protrude leftward and rightward from the first bridge to discharge the light beams emitted from the light sources to an outside of the first bridge.

19. An electronic shift operation apparatus comprising:
a gear shifter positioned on a steering column of a vehicle and configured to be manipulated by a driver to perform a shift operation;
a starting unit provided on the gear shifter and configured to be manipulated to start the vehicle; and
a shift position light guide provided on the gear shifter and configured to transmit light beams emitted from a light source to an indicator configured to indicate a shift position.

20. The electronic shift operation apparatus of claim 19, wherein a number of shift positions of the vehicle indicated by the indicator is two or more, and
wherein the shift position light guide has a structure integrated into a single component, individually separates the light beams emitted from the light source, and transmits the light beams to the shift positions indicated by the indicator.
